(19) United States
(12) Patent Application Publication
(10) Pub. No.: US 2012/0325187 A1
(43) Pub. Date: Dec. 27, 2012

(54) EGR FLOW CONTROL FOR LARGE ENGINES

(75) Inventors: RAMMOHAN SANKAR, DUNLAP, IL (US); TRAVIS BARNES, METAMORA, IL (US)

(73) Assignee: CATERPILLAR INC., PEORIA, IL (US)

(21) Appl. No.: 13/165,113

(22) Filed: Jun. 21, 2011

(51) Int. Cl. F02B 47/08

(52) U.S. Cl. 123/568.21

(57) ABSTRACT

An internal combustion engine and control system are provided having improved efficiency through improved exhaust flow control. The engine includes at least one bank of combustion cylinders and a respective exhaust manifold for conveying exhaust to the atmosphere. Further included is an exhaust gas restriction valve (ERV) associated with the exhaust manifold for selectively increasing backpressure on the associated bank of combustion cylinders and for redirecting a portion of the exhaust into an exhaust gas conditioning system for conditioning the portion of the exhaust and returning it to an air intake of the engine. An engine exhaust gas recirculation (EGR) valve in the exhaust gas recirculation system restricts the flow of conditioned exhaust, and an EGR flow controller operates the EGR valve in one of a substantially open and substantially closed condition and controls the flow of conditioned exhaust to the air intake by modulating the ERV.

### TECHNICAL FIELD

This disclosure relates generally to an internal combustion engine and, more particularly, to an internal combustion engine with a flow controlled exhaust gas recirculation system.

### BACKGROUND

An exhaust gas recirculation system may be used to reduce the generation of undesirable pollutant gases during the operation of internal combustion engines. Exhaust gas recirculation systems generally recirculate exhaust gas generated during the combustion process into the intake air supply of the internal combustion engine. The exhaust gas introduced into the engine cylinders displaces a volume of the intake air supply that would otherwise be available for oxygen. Reduced oxygen concentrations lower the maximum combustion temperatures within the cylinders and slow the chemical reactions of the combustion process, which decreases the formation of oxides of nitrogen (NOₓ).

Many internal combustion engines having such an exhaust gas recirculation system also have one or more turbochargers. Exhaust gas from the combustion cylinders is typically used to drive the turbocharger of the turbocharger which, in turn, drives the compressor of the turbocharger to compress fluid that is subsequently supplied to the combustion cylinders. A portion of the exhaust gas may also be diverted from the exhaust system used to drive the turbocharger and into the exhaust gas recirculation system.

U.S. Pat. No. 6,263,272 discloses an exhaust gas recirculation system for an internal combustion engine, including a turbocharger, restrictor valve, and exhaust gas recirculation valve. The restrictor valve is upstream of the turbine of the turbocharger, and restricts the flow of exhaust gas into the turbine. This restriction results in an increase in pressure of the exhaust gas provided to the restrictor valve. The increased pressure exhaust gas is provided to the inlet of an exhaust gas recirculation valve. The '272 patent specification states that the restrictor valve may be modulated until exhaust pressure is greater than the pressure of the intake gas. The '672 restrictor valve may also be operated without recirculation of exhaust gas to increase the load on the engine and decrease the warm-up time.

The foregoing background discussion is intended solely to aid the reader. It is not intended to limit the innovations described herein nor to limit or expand the prior art discussed. Thus the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY

In one aspect of the disclosure, an internal combustion engine is provided having improved efficiency through improved exhaust flow control is provided. The engine includes at least one bank of combustion cylinders and at least one respective exhaust manifold for receiving exhaust from the at least one bank of combustion cylinders and conveying the received exhaust to the atmosphere. Further included is an exhaust gas restriction valve (ERV) associated with the exhaust manifold for selectively increasing backpressure on the associated bank of combustion cylinders and for redirecting a portion of the exhaust into an exhaust gas conditioning system for conditioning the portion of the exhaust and returning it to an air intake of the engine. An engine exhaust gas recirculation (EGR) valve in the exhaust gas recirculation system restricts the flow of conditioned exhaust, and an EGR flow controller operates the EGR valve in one of an open and closed condition and controls the flow of conditioned exhaust to the air intake by modulating the ERV.

In a further aspect, an engine exhaust gas recirculation system is provided having a first valve for selectively directing engine exhaust to an exhaust gas conditioning system and a second valve for restricting an output of the exhaust gas conditioning system to an air intake of the engine, wherein the second valves is a substantially two position valve. A controller controls the first and second valves to achieve a determined level of exhaust gas recirculation to the air intake of the engine.

In yet another aspect, a method is provided for controlling recirculation of engine exhaust in a recirculation system having a first valve for selectively directing engine exhaust to an exhaust gas conditioning system and a second valve for restricting an output of the exhaust gas conditioning system to an air intake of the engine, wherein the second valves is a substantially two position valve. The method includes controlling the first and second valves to achieve a determined level of exhaust gas recirculation to the air intake of the engine by setting the second valve at one of an on position and an off position and varying the position of the first valve to achieve the determined level of exhaust gas recirculation.

Other features and advantages of the described systems and methods will be appreciated from the detailed description in conjunction with the attached drawings of which:

### BRIEF DESCRIPTION OF THE DRAWINGS

FIG. 1 is a schematic illustration of an internal combustion engine in accordance with the disclosure;

FIG. 2 is a perspective view of the exhaust manifolds and the exhaust gas balance tube in accordance with the disclosure;

FIG. 3 is an enlarged bottom view of a portion of the exhaust manifolds and the exhaust gas balance tube of FIG. 2;

FIG. 4 is a schematic illustration of an internal combustion engine of an alternate embodiment having a single bank of combustion cylinders;

FIG. 5 is a simplified control schematic according to an embodiment of the disclosed principles; and

FIG. 6 is an EGR valve control plot showing valve positioning and transition response according to an aspect of an embodiment.

### DETAILED DESCRIPTION

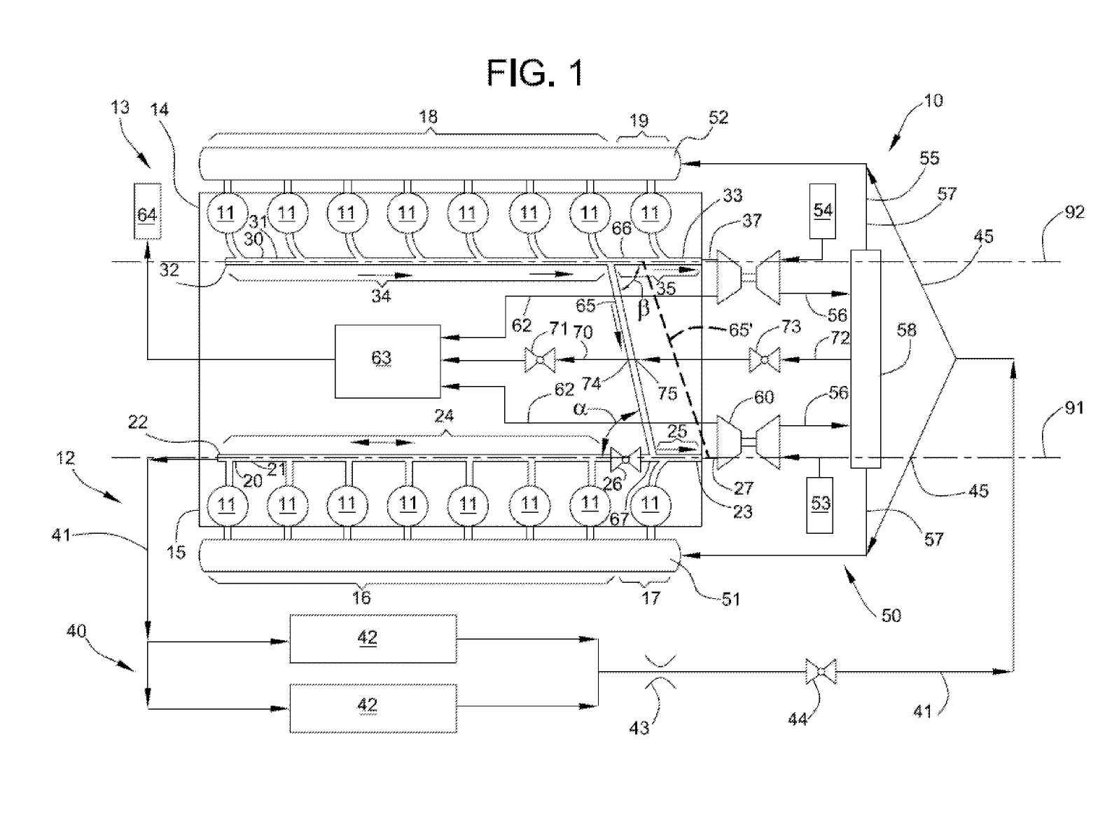

FIG. 1 depicts an internal combustion engine 10 having a plurality of combustion cylinders 11 configured as a first cylinder bank 12 and a second cylinder bank 13 generally parallel to the first cylinder bank. A first exhaust gas line 20 is fluidly connected to the first cylinder bank 12 and a second exhaust gas line 30 is fluidly connected to the second cylinder bank 13. Compressed air is supplied to the first and second cylinder banks 12, 13 by air intake 50. An exhaust gas recirculation system 40 provides for the recirculation of exhaust gas into the air intake 50 in order to reduce the emissions of the internal combustion engine 10.

A first cylinder head 14 is secured to the internal combustion engine 10 adjacent the first cylinder bank 12 and a second cylinder head 15 is secured to the internal combustion engine adjacent the second cylinder bank 13 of combustion cylinders. The first cylinder bank 12 includes a first cylinder group 16 and a second cylinder group 17. The second cylinder bank 13 includes a first cylinder group 18 and a second cylinder group 19. While the first cylinder group 16 of first cylinder bank 12 and the first cylinder group 18 of the second cylinder bank 13 are each depicted with seven combustion cylinders 11 and the second cylinder group 17 of the first cylinder bank 12 and the second cylinder group 19 of the second cylinder bank 13 are each depicted with one combustion cylinder 11, the combustion cylinders of each cylinder bank may be grouped as desired to define or form cylinder groups having different numbers of combustion cylinders.

First exhaust gas line 20 includes a first exhaust manifold 21 that is fluidly connected to the first cylinder bank 12. First exhaust manifold 21 has a first end 22 and an opposite exhaust end 23 with a first section 24 and a second section 25 between the two ends. An exhaust gas control valve 26 is positioned between the first section 24 and the second section 25. A first extension pipe 27 extends between the exhaust end 23 of first exhaust manifold 21 and first turbocharger 60 and fluidly connects the first exhaust manifold to the first turbocharger.

Second exhaust gas line 30 includes a second exhaust manifold 31 that is fluidly connected to the second cylinder bank 13. The second exhaust manifold 31 is generally parallel to the first exhaust manifold and has a first end 32 and an opposite exhaust end 33 with a first section 34 and a second section 35 between the two ends. A second extension pipe 37 extends between the exhaust end 33 of the second exhaust manifold 31 and second turbocharger 61 and fluidly connects the second exhaust manifold to the second turbocharger.

Exhaust gas from the first cylinder group 16 of the first cylinder bank 12 is received within the first section 24 of the first exhaust manifold 21 and, depending upon the positions of exhaust gas control valve 26 and exhaust gas recirculation valve 44, may be routed through the exhaust gas recirculation system 40. The exhaust gas recirculation system 40 includes an exhaust gas recirculation duct 41 that is fluidly connected to the first end 22 of the first exhaust gas line 20 so that exhaust gas from the first cylinder group 16 of the first cylinder bank 12 may be routed or recirculated through the exhaust gas recirculation system and introduced into the combustion air intake 50.

Exhaust gas passing through exhaust gas recirculation duct 41 is cooled by one or more cooling components 42. The flow rate through exhaust gas recirculation duct 41 is monitored by a flow meter 43 such as a venturi-style flow meter. An exhaust gas recirculation valve 44 is provided along exhaust gas recirculation duct 41 to control exhaust gas flow through the exhaust gas recirculation system 40. Exhaust gas recirculation valve 44, together with exhaust gas control valve 26, controls the amount of exhaust gas that is mixed with air that has been compressed by the first turbocharger 60 and the second turbocharger 61 prior to the air entering the first intake manifold 51 and the second intake manifold 52. The exhaust gas recirculation duct 41 of the exhaust gas recirculation system 40 splits into two separate legs 45. Each leg 45 fluidly connects to the air intake 50 between the aftercooler 58 and the first intake manifold 51 and the second intake manifold 52, respectively.

Air intake 50 includes a first air intake 53 through which atmospheric air enters the first turbocharger 60, a second air intake 54 through which atmospheric air enters the second turbocharger 61 and a compressed air line 55 through which compressed air is fed to combustion cylinders 11. Atmospheric air is compressed by the first and second turbochargers 60, 61 and passes through first compressed air lines 56 to aftercooler 58. Cooled compressed air exits the aftercooler 58 and enters second compressed air lines 57 that are each fluidly connected to a respective one of the first and second intake manifolds 51, 52. Each leg 45 of the exhaust gas recirculation system 40 intersects with and fluidly connects to a respective one of the second compressed air lines 57 between the aftercooler 58 and the first and second intake manifolds 51, 52. In this way, exhaust gas may be mixed with intake air provided to the combustion cylinders 11.

A portion of exhaust gas from the first cylinder group 16 of the first cylinder bank 12 is, at times, routed through the exhaust gas recirculation system 40 rather than through the first exhaust gas line 20. For this reason, a duct or exhaust gas balance tube 65 is fluidly connected between the first exhaust gas line 20 and the second exhaust gas line 30 to balance or equalize, to a controllable extent, the amount of exhaust gas passing through the first and second turbochargers 60, 61. More specifically, second exhaust manifold 31 includes an upstream balance tube connection port 66 (FIGS. 1-3) between the first section 34 of second exhaust manifold 31 and the second section 35 of the second exhaust manifold. First exhaust manifold 21 includes a downstream balance tube connection port 67 positioned between exhaust gas control valve 26 and the second section 25 of the first exhaust manifold 21. In other words, the upstream balance tube connection port 66 fluidly connects one end of exhaust gas balance tube 65 to the second exhaust manifold 31 and the downstream balance tube connection port 67 fluidly connects the opposite end of the exhaust gas balance tube to the first exhaust manifold 21 to permit exhaust gas to pass from the second exhaust gas line 30 to the first exhaust gas line 20. The exhaust gas balance tube 65 provides a path for exhaust gas to travel from second exhaust gas line 30 towards first exhaust gas line 20 to balance the flow through the first and second turbochargers 60, 61.

It should be noted that while the upstream balance tube connection port 66 is depicted as being positioned between the first section 34 of the second exhaust manifold 31 and the second section 35 of the second exhaust manifold, the upstream balance tube connection port may alternatively be positioned elsewhere along the second exhaust manifold 31 to provide the desired amount of exhaust gas through exhaust gas balance tube 65. For example, moving the upstream balance tube connection port 66 upstream or towards first end 32 of second exhaust manifold 31 will result in fewer combustion cylinders 11 being included in first cylinder group 18 of second cylinder bank 13 and thus exhaust gas from fewer combustion cylinders will be available for passage through exhaust gas balance tube 65 to first exhaust gas line 20.

Downstream balance tube connection port 67 is depicted as being positioned between the exhaust gas control valve 26 and the second section 25 of the first exhaust manifold 21. However, the downstream balance tube connection port 67 may be positioned at other locations along the first exhaust manifold 21 as well as other positions along the first exhaust gas line 20, such as that depicted in phantom at 65′ in FIG. 1 and connected to the first extension pipe 27 between the first exhaust manifold and the first turbocharger 60.

Exhaust gas balance tube 65 and upstream balance tube connection port 66 engage or meet second exhaust gas line 30 at an angle “β” relative to centerline 92 of second exhaust manifold 31. In order to minimize pressure drop though the exhaust gas balance tube 65, it is believed that setting angle “β” at an angle less than ninety degrees will result in acceptable flow characteristics and setting angle “β” at less than approximately eighty degrees will further reduce the pressure drop and still smaller angles will likely reduce the pressure drop to a greater extent. The exact angle may be set by based upon air flow characteristics and desired routing of the exhaust gas balance tube 65 within the physical space limitations of the internal combustion engine.

Exhaust gas balance tube 65 and the downstream balance tube connection port 67 engage or meet first exhaust gas line 20 at an angle “α” relative to centerline 91 of first exhaust manifold 21. With this configuration, exhaust gas flowing from the second exhaust gas line 30 through exhaust gas balance tube 65 into first exhaust gas line 20 does not enter first exhaust gas line 20 in a perpendicular fashion relative to first exhaust gas line 20 and thus pressure drop through the exhaust gas balance tube 65 is reduced. In addition, since the exhaust gas traveling downstream through first exhaust gas line 20 drives the first turbocharger 60, it is desirable that the exhaust gas passing through the exhaust gas balance tube 65 into the first exhaust gas line 20 minimizes any disruption to the flow or momentum of the exhaust gas from first cylinder group 16 of first cylinder bank 12 as it passes downstream balance tube connection port 67. By positioning the downstream balance tube connection port 67 at an appropriate angle relative to the centerline of the first exhaust gas line 20, disruption of the flow through the first exhaust gas line may be reduced or minimized. It is believed that setting the angle “α” to less than ninety degrees will result in acceptable flow characteristics. It is further believed that setting the angle “α” at less than approximately seventy-five degrees will result in a configuration that will minimize disruption of air flow within the first exhaust gas line 20. The exact angle may be set based upon air flow characteristics and desired routing of the exhaust gas balance tube 65 within the physical space limitations of the internal combustion engine. It should be noted that angles “α” and “β” are not necessarily within a horizontal or a vertical plane relative to internal combustion engine 10 nor do they need to be identical angles.

Exhaust gas from the first cylinder bank 12 and second cylinder bank 13 passes through the first and second turbochargers 60, 61, respectively, and exits the turbochargers through turbocharger exhaust gas lines 62. Turbocharger exhaust gas lines 62 are fluidly connected to a filter 63 so that the exhaust gas is filtered prior to being discharged or released to the atmosphere through exhaust gas outlet 64.

Under certain operating conditions, it may be desirable to reduce the shaft speed of the first and second turbochargers 60, 61 so that the turbochargers may be maintained within a desired operating range. In order to do so, the amount of exhaust gas passing through the first and second exhaust gas lines 20, 30 may be reduced by venting or releasing a desired amount of exhaust gas from the exhaust gas lines. Such exhaust gas may be released in a relatively consistent manner from both the first and second exhaust gas lines 20, by utilizing a wastegate 70 that is fluidly connected at wastegate interconnection 74 to exhaust gas balance tube 65 to permit exhaust gas to be released from the wastegate. A wastegate valve 71 controls or regulates the flow of exhaust gas through wastegate 70. By fluidly connecting wastegate 70 to exhaust gas balance tube 65, exhaust gas within the first and second exhaust gas lines 20, 30 may be reduced in a relatively uniform manner so that a reduction in shaft speed of the first and second turbochargers 60, 61 will also occur in a relatively uniform manner.

Under certain other operating conditions, it may be desirable to reduce the pressure within the compressed air line 55. In such case, a compressor bypass 72 and its associated compressor bypass valve 73 may be used to control or regulate the venting or release of compressed air from the compressed air line 55. However, because work has been performed (i.e., energy used) to compress the air within the compressed air line 55, such energy is wasted if the compressed air is vented or released to the atmosphere. In order to increase the efficiency of internal combustion engine 10, the compressor bypass 72 fluidly connects the compressed air line 55 at aftercooler 58 (but before the compressed air is cooled within the aftercooler) with the exhaust gas balance tube 65 at compressor bypass interconnection 75. In this way, energy used to compress the atmospheric air within the first and second turbochargers 60, 61 is conserved by re-routing the compressed air into the exhaust gas system via the exhaust gas balance tube 65 when the pressure of air in the compressed air line 55 is higher than exhaust gas pressure within the exhaust gas balance tube 65. In other words, rather than wasting the energy used to compress the air that is being vented or released to the atmosphere, some of the energy may be saved by re-routing the compressed air into the exhaust gas system which is subsequently used to drive the first and second turbochargers 60, 61. In an alternate design, the compressor bypass may extend from any portion of compressed air line 55, including a portion positioned after the aftercooler 58. In addition, the compressor bypass may be routed to fluidly connect to the exhaust gas system at a location other than the exhaust gas balance tube 65 including either or both of the first and second exhaust gas lines 20, 30.

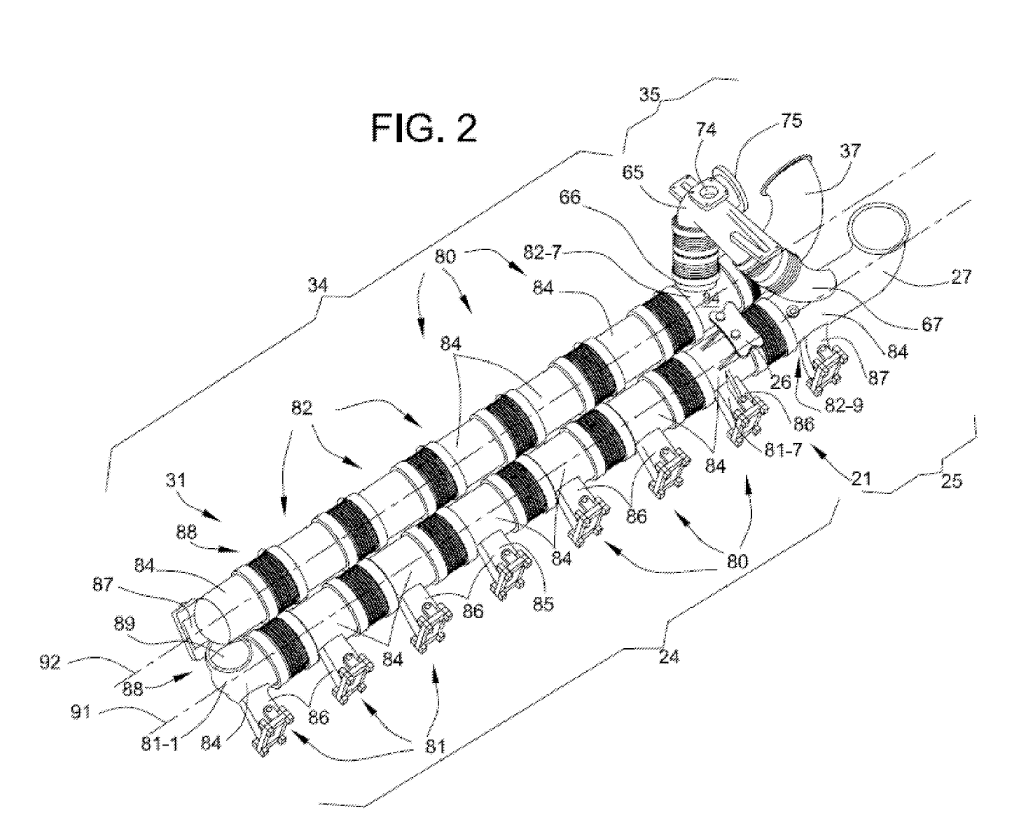

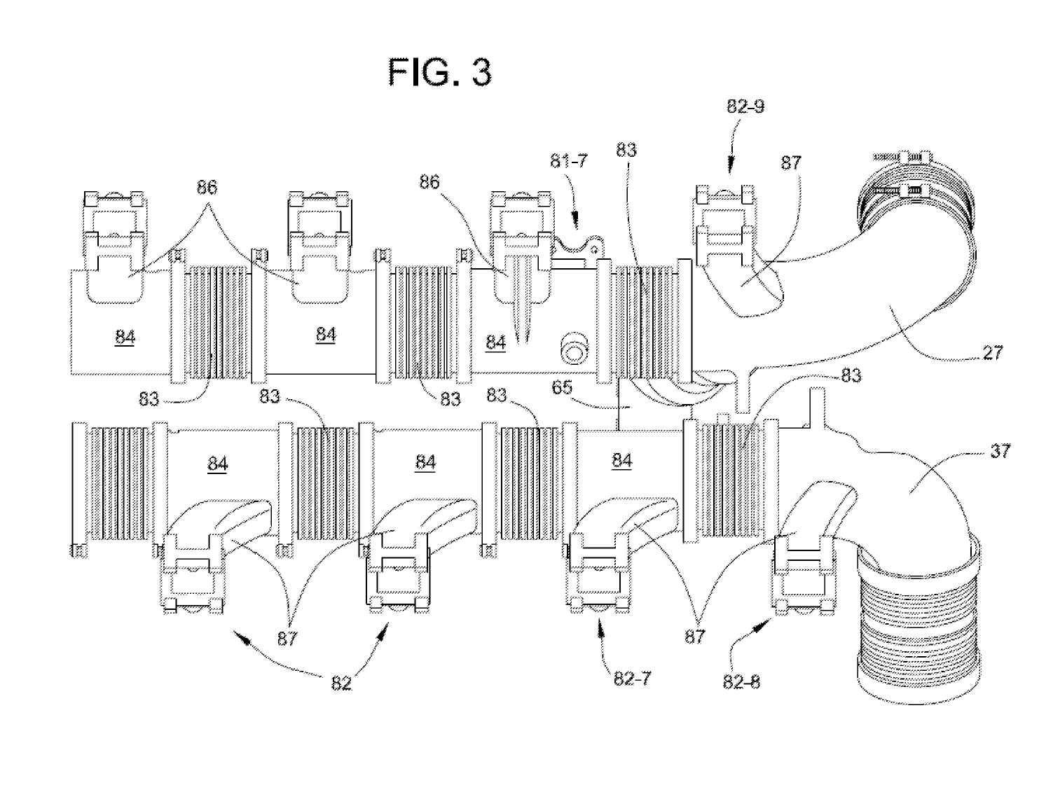

Referring to FIGS. 2-3, the first exhaust manifold 21 and the second exhaust manifold 31 are each formed of a plurality of interconnected exhaust manifold elements 80. More specifically, first exhaust manifold 21 includes seven non-direction specific exhaust manifold elements 81 that are each fluidly connected to one of the combustion cylinders 11 of the first cylinder group 16. The first exhaust manifold 21 further includes one modular pulse exhaust manifold element 82 positioned adjacent exhaust end 23 of the first exhaust manifold 21 and fluidly connected to the single combustion cylinder 11 of the second cylinder group 17 of the first cylinder bank 12. Each of the non-direction specific exhaust manifold elements 81 and the modular pulse exhaust manifold element 82 is mechanically and fluidly connected to an adjacent manifold element by connecting members 83. The connecting members 83 may be formed with a bellows, a slip-fit joint or another structure that is capable of expanding and contracting to compensate for thermal expansion of the exhaust manifold elements 80. Each exhaust manifold element 80 includes a generally cylindrical hollow duct component 84 and a hollow pipe component 85 for fluidly connecting a combustion cylinder 11 to the duct component 84. The duct components 84 of the exhaust manifold elements 80 are spaced apart in an array connected by the connecting members 83 to form a generally linear tube-like duct portion 88 of the first exhaust manifold for directing exhaust gas from each combustion cylinder towards the exhaust end 23 of the first exhaust manifold. In other words, each of the connecting members 83 and duct components 84 is positioned along and forms a section of the generally linear tube-like duct portion 88.

All of the non-direction specific exhaust manifold elements 81 and the modular pulse exhaust manifold element 82 have generally identical duct components 84 except as described below. Non-direction specific exhaust manifold element 81 has a non-direction specific pipe component 86 that generally extends from the first cylinder head 14 in a generally straight manner to duct component 84. In the depicted embodiment, the non-direction specific pipe components 86 are generally perpendicular to axis 91 of first exhaust manifold 21 so that the non-direction specific exhaust manifold elements have a generally “T-shaped” configuration.

Modular pulse exhaust manifold element 82 has a curved modular pulse pipe component 87 that generally extends from the first cylinder head 14 and fluidly connects the combustion cylinder 11 of the second cylinder group 17 of the first cylinder bank 12 to the duct component 84 of the modular pulse exhaust manifold element 82. The modular pulse pipe component 87 is configured to direct exhaust gas from a combustion cylinder 11 into the first exhaust manifold in a direction specific or direction biased exhaust flow pattern that includes the generation of a series of pulses of exhaust gas. In addition, the shape of the modular pulse pipe component 87 combined with the duct component 84 directs the exhaust gas towards the exhaust end 23 of the first exhaust manifold 21 and thus towards the first turbocharger 60.

The second exhaust manifold 31 is constructed in a manner similar to first exhaust manifold 21 and also has eight exhaust manifold elements 80. However, all of the exhaust manifold elements are modular pulse exhaust manifold elements 82 in order to direct exhaust gas from the second cylinder bank 13 and through the second exhaust gas line 30 towards the second turbocharger 61.

In the embodiment depicted in FIGS. 1-3, each of the exhaust manifold elements of the first exhaust manifold 21 associated with the first cylinder group 16 of first cylinder bank 12 is a non-direction specific exhaust manifold element 81 while the exhaust manifold element associated with the second cylinder group 17 of the first cylinder bank 12 is a modular pulse exhaust manifold element 82. As such, the first exhaust manifold 21 has both non-direction specific exhaust manifold elements 81 and a modular pulse exhaust manifold element 82.

By configuring the exhaust manifold elements of the first section 24 of the first exhaust manifold as non-direction specific exhaust manifold elements, exhaust gas may flow more easily towards the exhaust end 23 of first exhaust manifold 21 as well as towards exhaust gas recirculation system 40. If the exhaust manifold elements of the first section 24 of the first exhaust manifold were modular pulse exhaust manifold elements, the exhaust gas from the first section would be primarily directed towards exhaust end 23 of the first manifold. With such a modular pulse configuration, in order to increase the amount of exhaust gas being recirculated through the exhaust gas recirculation system 40, the exhaust gas control valve 26 would be closed to a greater extent than if, as disclosed herein, the first exhaust manifold includes both non-direction specific exhaust manifold elements and modular pulse exhaust manifold elements. As a result, the configuration of the first exhaust manifold 21 results in a more efficient structure for the recirculation of exhaust gas.

The exhaust manifold elements may also include additional features and functionality. For example, non-direction specific exhaust manifold element 81-1 adjacent first end 22 of first exhaust manifold 21 has an opening 89 for fluidly connecting first exhaust manifold 21 to exhaust gas recirculation duct 41. Non-direction specific exhaust manifold element 81-7 includes exhaust gas control valve 26 to define the first cylinder group 16 and the second cylinder group 17. Modular pulse exhaust manifold element 82-9 of first exhaust manifold 21 includes the downstream balance tube connection port 67 for fluidly connecting to exhaust gas balance tube 65 and also includes the first extension pipe 27 in the shape of a curved end component for fluidly connecting to first turbocharger 60. Modular pulse exhaust manifold element 82-7 of second exhaust manifold 31 includes the upstream balance tube connection port 66 for fluidly connecting to exhaust gas balance tube 65. Modular pulse exhaust manifold element 82-8 (FIG. 3) of second exhaust manifold 31 includes the second extension pipe 37 in the shape of a curved end component for fluidly connecting to second turbocharger 61.

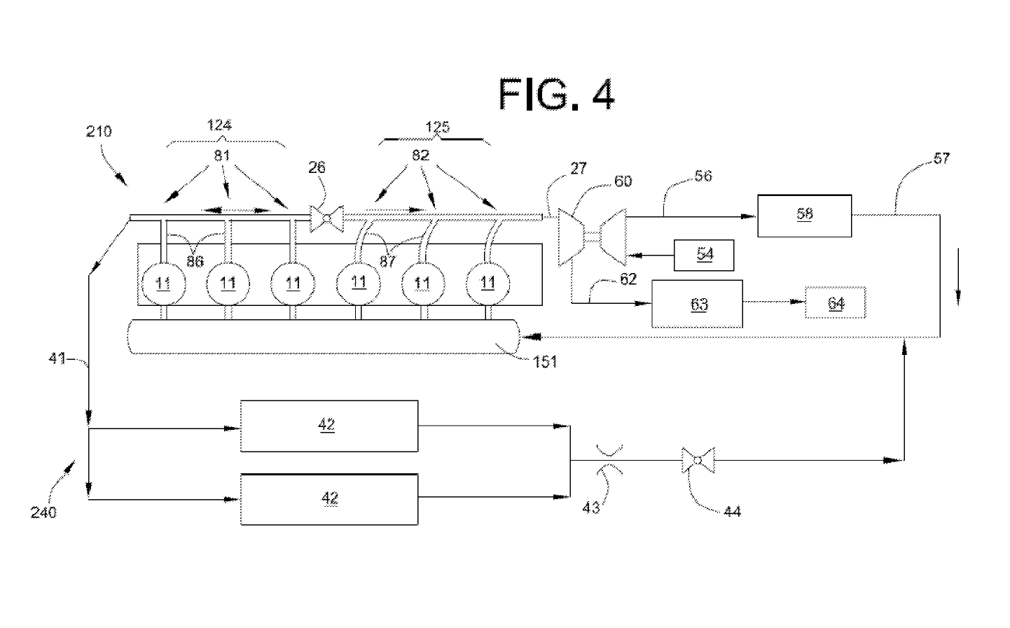

Although the internal combustion engine 10 and associated components depicted in FIGS. 1-3 include or relate to a pair of cylinder banks, certain aspects of the present disclosure may be used with internal combustion engines having a single, in-line bank of combustion cylinders. FIG. 4 depicts an internal combustion engine 210 similar to internal combustion engine 10 of FIG. 1 but having only a single, in-line cylinder bank 212. Identical or similar components of the embodiment depicted in FIG. 1 are identified with identical reference numbers.

Although the described EGR system configuration and resultant operation serve to significantly increase engine efficiency and lower engine emissions, the system is most beneficially operated when the recirculation is accurately controlled to provide the optimal mixture of fresh and recirculated charge. As discussed above, the described system includes an engine EGR valve 44 located between combustion cylinders 11 as well as an exhaust gas restriction valve (ERV) 26, both of which affect the extent to which recirculation occurs. For example with the EGR valve 44 closed and the ERV 26 open, flow is at a minimum, whereas with the EGR valve 44 open and the ERV 26 closed, flow is at a maximum.

However, neither state is ideal for system efficiency. For example, the ERV 26 serves a diversion function for recirculation purposes but also provides backpressure to improve engine operation under certain running conditions. Moreover, during certain other running conditions, backpressure may need to be removed, and yet unrestricted exhaust gas recirculation would negatively affect engine performance, efficiency, and emissions.

To this end, in an embodiment, for low EGR flow conditions, the EGR valve 44 is used to control EGR flow rate with the ERV 26 fully open. For higher flow levels, the EGR valve 44 is fully opened and the recirculation is controlled by modulating the state of the ERV 26. In an embodiment, the EGR valve 44 is smoothly transitioned between the on and off states when the flow requirement falls within a predefined range about the division between the low flow and high flow control regimes to provide a smooth transition.

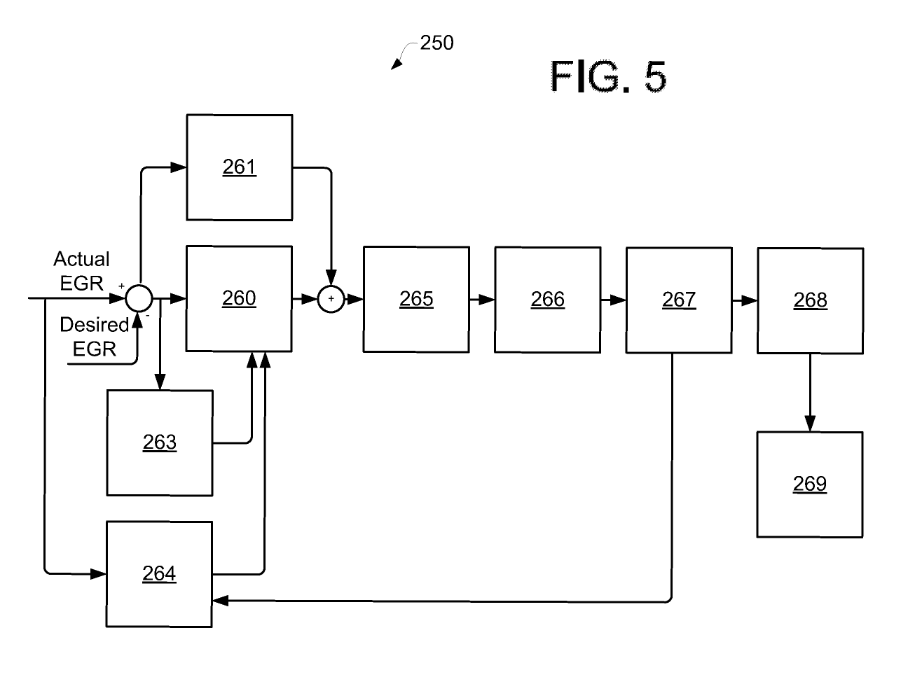

A control architecture for executing the described valve control schema is shown schematically in FIG. 5. In particular, the simplified control schematic 250 includes a number of interacting components including a nonlinear proportional integral control module 260 and an ERV feed forward control module 261. The feed forward strategy in an embodiment takes the desired EGR flow and provides an initial control flow area. To account for system changes that are condition dependent, the feed forward gain may be determined from a map that is function of engine speed and fuel.

The nonlinear proportional integral control module 260 receives as input the difference between the actual EGR and a desired EGR, and provides a standard PI output based on this information. For executing the PI function, the proportional integral control module 260 also receives a scheduled gain from an ERV control gain schedule 263 and an integral parameter from an integrator and freeze initiation module 264.

In an embodiment, the control gains used on the closed loop control are gain scheduled to account for EGR response changes due to operating conditions. The maps may be, as noted above, a function of engine speed and fuel. In addition, non-linear control action may be used as a function of error to improve response during transient conditions. Regarding the integrator and freeze initiation module 264, the integrator is frozen when the ERV reaches either the maximum or minimum values and is trying to move beyond the limits. This prevents integrator wind-up and associated problems. The integrator may be initialized before starting the closed loop control to guarantee that the control is starting from a known condition

In the illustrated example, the ERV control gain schedule 263 has as its input the aforementioned difference. Similarly, the integrator and freeze initiation module 264 takes the desired EGR as its input along with a limit value to be discussed later.

In parallel, the ERV feed forward control module 261 receives as input the aforementioned difference, and outputs a control signal to be summed with the PI output of the proportional integral control module 260. The summed or controlled output is then fed to an ERV valve characterization function 265 to generate an ERV control area, e.g., in mm².

The generated ERV control area is then used by an ERV valve area selector 266 to select a final needed valve area. The final needed valve area is limited by a limiting strategy module 267 to produce a limited area which is also fed back to the integrator and freeze initiation module 264 as discussed above. The limited area which is also input to an ERV linearization module 268 to produce a desired hot valve position which is then fed to the appropriate actuation system 269. Regarding the limited area, the ERV is limited to a maximum and minimum area in an embodiment. The maximum may be the wide-open area. The minimum may be a function of engine speed and fuel to prevent the valve from going to a position that could cause engine damage.

Regarding the ERV linearization module 268, the EGR mass flow is a function of ERV valve position, but the gain of the flow to the valve position is non-linear and condition dependent. Thus, in an embodiment, a decoupling function is used to decouple the flow response to the valve position at different operating conditions. The controls are based on area to keep the outputs as linear as possible to the physics of the system. The ERV valve control is position (0-1), so a linearization map is used within the ERV linearization module 268 to convert the area to position.

Turning now to the cold EGR valve 44, the control of the valve is structured to be open or closed. When the engine is operating in a quasi-steady state condition, the valve may be ramped rather than stepped between positions to minimize disturbances in the engine output. However, during a hard transient event, the valve may step to the new position to minimize impact on emissions.

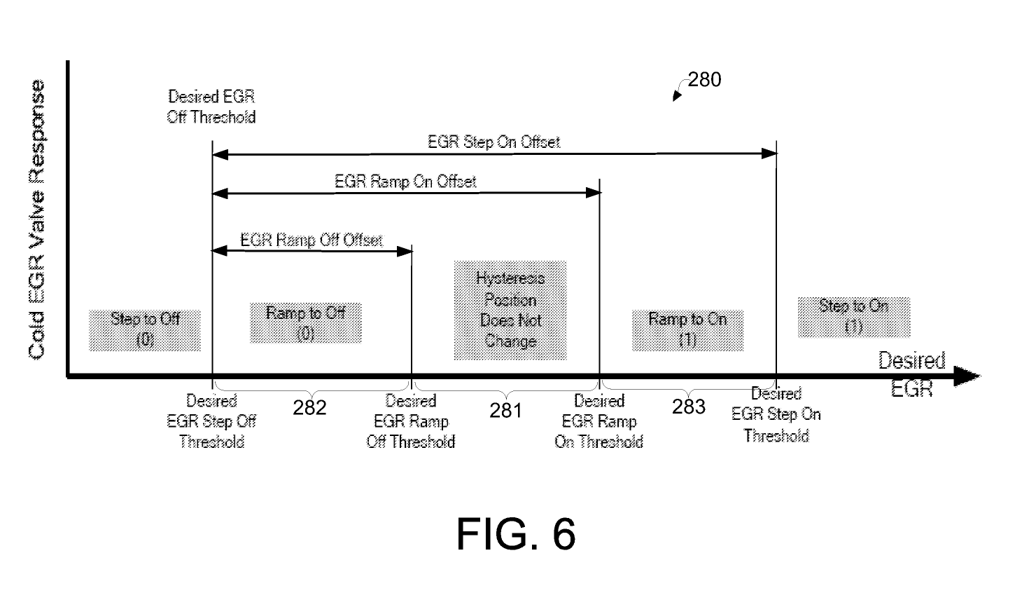

An exemplary control schema 280 is shown in FIG. 6. The illustrated schema 280 plots the EGR valve 44 state as a function of desired position. Thus, the valve has two positions, on and off, and four state transitions, namely (1) ramp off, (2) step off, (3) ramp on and (4) step on. Per the illustrated strategy, a hysteresis region 281 is established wherein the controller maintains the valve in whatever state it is in without change while the desired EGR remains in the region.

The hysteresis region 281 is bounded by a ramp off region 282 on the lower end and a ramp on region 283 on the upper end. If the desired EGR falls within one of these regions, the controller ramps the position of the EGR valve 44 to the appropriate on or off position to avoid an abrupt change. If however, the desired EGR falls below the ramp off region 282 or above the ramp on region 283, then the controller steps the position of the EGR valve 44 to the new position to avoid a substantial response lag time during which emissions and efficiency may suffer.

It will be appreciated that each module may receive other inputs, not shown, depending upon the implementation chosen. Moreover, while the description of the control architecture references modules that execute various steps and functions, these modules need not be implemented strictly in hardware. For example, in an embodiment, one or more modules may be a software module, i.e., a computerized execution of computer-executable code read from a computer-readable medium. The computer-readable medium is a nontransitory medium such as, but not limited to a RAM, ROM, EPROM, disc memory, flash memory, optical memory, and so on.

### INDUSTRIAL APPLICABILITY

The industrial applicability of the system described herein will be readily appreciated from the foregoing discussion. The present disclosure is applicable to many internal combustion engines. One exemplary type of such an internal combustion engine is one that utilizes an exhaust gas recirculation system. The internal combustion engine may utilize an EGR valve 44 in cooperation with an ERV 26 to selectively recirculate exhaust gases back to the engine combustion chambers as a variable part of the combustion charge. The exhaust gas recirculation improves engine efficiency and emission characteristics, but can also negatively affect these characteristics if not accurately performed.

The described system includes a controller for coordinating the control of both recirculation valves (EGR valve 44 and ERV 26) based on the current operating state of the engine, in order to maintain appropriate exhaust manifold back pressure on some or all cylinders while still allowing the prescribed degree of recirculation to occur. Thus, during normal operation, the EGR valve 44 is maintained in an open state and the ERV 26 is utilized to provide recirculation flow control. However, during low EGR flow conditions, the ERV 26 is fully opened.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An engine system comprising:
at least one bank of combustion cylinders and at least one respective exhaust manifold for receiving exhaust from the at least one bank of combustion cylinders and conveying the received exhaust to the atmosphere;
an exhaust gas restriction valve (ERV) associated with the exhaust manifold for selectively increasing backpressure on the associated bank of combustion cylinders and for redirecting a portion of the exhaust into an exhaust gas conditioning system for conditioning the portion of the exhaust and returning it to an air intake of the engine;
an engine exhaust gas recirculation (EGR) valve in the exhaust gas recirculation system for restricting the flow of conditioned exhaust; and
an EGR flow controller that operates the EGR valve in one of two or more discrete positions and controls the flow of conditioned exhaust to the air intake by modulating the ERV under a first set of conditions.

2. The engine system of claim 1 wherein the exhaust gas conditioning system includes an EGR cooler and wherein the EGR valve is located downstream of the EGR cooler.

3. The engine system of claim 1 wherein the engine includes a turbocharger and wherein the ERV is located upstream of the turbocharger.

4. The engine system of claim 1 wherein the at least one bank of combustion cylinders includes a plurality of cylinders and wherein the ERV is located between cylinders so as to selectively divert the exhaust of only a portion of the cylinders.

5. The engine system of claim 1 wherein the EGR flow controller controls the EGR valve based on a desired EGR rate, and wherein the controller is adapted to fully change the state of the EGR valve from the one of the two or more discrete positions to another one of the two or more discrete positions in a step manner under a first set of conditions and to gradually open the EGR valve from the one of the two or more discrete positions to the other one of the two or more discrete positions under a second set of conditions.

6. The engine system of claim 6 wherein the first set of conditions includes a request for EGR that differs from the current EGR by more than a first predetermined amount.

7. The engine system of claim 6 wherein the second set of conditions includes a request for EGR that differs from the current EGR by less than the first predetermined amount but more than a second predetermined amount.

8. The engine system of claim 7 wherein the controller is adapted to leave the EGR valve in a current state upon receiving a request for EGR that differs from the current EGR by less than the second predetermined amount.

9. An engine exhaust gas recirculation system comprising:
a first valve for selectively directing engine exhaust to an exhaust gas conditioning system;
a second valve for restricting an output of the exhaust gas conditioning system to an air intake of the engine, wherein the second valve is a substantially two position valve; and
a controller for controlling the first and second valves to achieve a determined level of exhaust gas recirculation to the air intake of the engine.

10. The engine exhaust gas recirculation system according to claim 10, wherein the exhaust gas conditioning system comprises an exhaust gas cooler.

11. The engine exhaust gas recirculation system according to claim 10, wherein the engine includes a turbocharger and wherein the first valve is located upstream of the turbocharger.

12. The engine exhaust gas recirculation system according to claim 11, wherein the controller is adapted to ramp the second valve between one of two discrete positions to the other one of the two discrete positions when a requested change in EGR falls below a predetermined magnitude.

13. The engine exhaust gas recirculation system according to claim 10, wherein the engine includes multiple cylinder banks, each having an exhaust manifold, and wherein the first valve is located on only one of the exhaust manifolds.

14. A method of controlling recirculation of engine exhaust in a recirculation system having a first valve for selectively directing engine exhaust to an exhaust gas conditioning system and a second valve for restricting an output of the exhaust gas conditioning system to an air intake of the engine, wherein the second valves is a substantially two position valve, the method comprising:
controlling the first and second valves to achieve a determined level of exhaust gas recirculation to the air intake of the engine by setting the second valve at a first one of two or more discrete positions and varying the position of the first valve to achieve the determined level of exhaust gas recirculation.

15. The method of controlling recirculation of engine exhaust according to claim 14, wherein setting the second valve at the first one of two or more discrete positions includes setting the position of the second valve based on the determined level of exhaust gas recirculation.

16. The method of controlling recirculation of engine exhaust according to claim 15, wherein setting the position of the second valve based on the determined level of exhaust gas recirculation comprises setting the position of the second valve based on a five region schema, wherein if the determined level of exhaust gas recirculation falls in one of two lower regions, the second valve is moved to a first position, if the determined level of exhaust gas recirculation falls in one of two upper regions the second valve is moved to a second position, and if the determined level of exhaust gas recirculation falls in a middle region, the position of the second valve is left unchanged.

17. The method of controlling recirculation of engine exhaust according to claim 14, wherein controlling the first and second valves to achieve a determined level of exhaust gas recirculation comprises employing nonlinear proportional integral control using a feed forward control schema.

18. The method of controlling recirculation of engine exhaust according to claim 17, wherein control gains on the closed loop control are gain scheduled to account for EGR response changes due to operating conditions.

19. The method of controlling recirculation of engine exhaust according to claim 18, wherein the control gains on the closed loop control are a function of engine speed and fuel consumption.

20. The method of controlling recirculation of engine exhaust according to claim 19, wherein a non-linear control is applied as a function of error to improve response during transient conditions.
